(19) United States
(12) Patent Application Publication
(10) Pub. No.: US 2005/0265467 A1
(43) Pub. Date: Dec. 1, 2005

(54) Intercarrier interference cancellation algorithm

(75) Inventors: Anand G. Dabak, Plano, TX (US); Jaiganesh Balakrishnan, Dallas, TX (US); Charles K. Sestok IV, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/061,977

(22) Filed: Feb. 18, 2005

Related U.S. Application Data
(60) Provisional application No. 60/574,396, filed on May 25, 2004.

(51) Int. Cl. H04K 1/10

(52) U.S. Cl. 375/260

(57) ABSTRACT

A method comprising wirelessly transmitting and receiving a data signal in an orthogonal frequency division multiplexing (OFDM) system. The method further comprises, in the frequency domain, at least partially removing overlap between a first received subcarrier frequency data and a second received subcarrier frequency data.

### CROSS-REFERENCE WITH RELATED APPLICATIONS

This application claims priority to U.S. Provisional Application No. 60/574,396, entitled, “ICI Cancellation Algorithm,” filed May 25, 2004, and hereby incorporated herein by reference.

### BACKGROUND

Orthogonal frequency division multiplexing (OFDM) is a modulation technique used in wireless systems to simultaneously transmit substantially large amounts of digital data over a wireless channel and to reduce data interference induced by the channel. In OFDM systems, a data signal is partitioned into multiple, smaller sub-signals, each of which is transmitted from a transmitter to a receiver over a different frequency. As in other wireless systems, data signals are broadcast in all directions. The signals may reflect off of objects in the environment, such as buildings and automobiles, and reach the receiver via multiple propagation paths.

Wireless communication systems that use OFDM may be categorized into any of a variety of classifications. One such classification is the linear, time-invariant (LTI) system. In LTI systems, channel conditions (e.g., the strength of each propagation path) do not substantially vary with time, such as when a transmitter and receiver are fixed in place. Because channel conditions do not vary to a considerable degree, the receiver may use information pertaining to the channel conditions to easily extract desirable data from a received signal (i.e., data that was originally transmitted by the transmitter) and to discard extraneous, undesirable data and/or effects imposed upon the signal by the channel.

However, in linear, time-variant (LTV) systems, such as wireless communication systems with substantially high Doppler conditions (e.g., where the distance between transmitter and receiver varies at speeds around 200-300 km per hour), channel conditions, such as the strength of each propagation path, may vary considerably with time. For example, at time t=0 min., a transmitter and receiver in an LTV system may be spaced 0.5 km. apart. Just minutes later, at time t=3 min., the same transmitter and receiver may be spaced 4.5 km apart. Channel conditions that were present at time t=0 min. may not be the same as those present at time t=3 min., since channel conditions may have changed due to, for example, the presence of mountainous terrain or high-rise buildings. Furthermore, signals en route to the receiver are subject to rapid variations in signal energy. These variations generally are caused by multiple signal reflections that are not in phase with each other. Because these rapid variations often occur faster than the rate at which the receiver can properly receive data, the receiver may not be able to accurately keep track of these variations, resulting in interference between data on different frequency sub-carrier signals (intercarrier interference, or “ICI”).

Because of these undesirable effects, it is difficult for a receiver in such a system to accurately extract desirable data from a received signal and to discard extraneous effects (e.g., ICI) imposed upon the signal prior to reception.

### SUMMARY

The problems noted above are solved in large part by an intercarrier interference cancellation algorithm and an apparatus for performing the same. One illustrative embodiment may be a method comprising wirelessly transmitting and receiving a data signal in an orthogonal frequency division multiplexing (OFDM) system. The method further comprises, in the frequency domain, at least partially removing overlap between a first received subcarrier frequency data and a second received subcarrier frequency data.

Another illustrative embodiment may be an orthogonal frequency division multiplexing (OFDM) communication system comprising a receiver adapted to, in the frequency domain, determine an unbiased, linear, minimum-squared error estimate of a transmitted data signal.

Yet another illustrative embodiment may be a receiver comprising a first logic adapted to decode a received data signal. The receiver further comprises a second logic coupled to the first logic and adapted to at least partially remove the overlap between received data on neighboring subcarrier frequencies in the frequency domain, wherein the receiver is in an orthogonal frequency division multiplexing (OFDM) system.

Yet another illustrative embodiment may be a logic comprising a plurality of dot product modules adapted to determine the dot product of a received data vector, a channel condition vector and a noise variance vector. The logic further comprises a divider module adapted to use the dot product to determine, in the frequency domain, a minimum-squared error estimate of a transmitted data signal.

### BRIEF DESCRIPTION OF THE DRAWINGS

For a detailed description of exemplary embodiments of the invention, reference will now be made to the accompanying drawings in which:

FIG. 1 shows a wireless communication system using orthogonal frequency division multiplexing (OFDM);

FIG. 2a shows a communication constellation used to encode binary data prior to transmission;

FIG. 2b shows a series of binary numbers to be encoded;

FIG. 2c shows a table comparing data points in the constellation of FIG. 2a, complex numbers pertaining to the data points, and binary number pairs from the series of FIG. 2b;

FIG. 3a shows a wireless OFDM communication system having multiple transmission paths in the wireless channel;

FIG. 3b shows a graph indicating an increase in the magnitude of b0(t);

FIG. 3c shows a graph indicating an increase in a signal pertaining to b0(t);

FIG. 3d shows a graph indicating an increase in the magnitude of b1(t);

FIG. 3e shows a graph indicating an increase in a signal pertaining to b1(t);

FIG. 4 shows a block diagram of a receiver in an OFDM system, in accordance with a preferred embodiment of the invention;

FIG. 5 shows a matrix B of b(t) values describing channel conditions, in accordance with embodiments of the invention;

FIG. 6 shows a matrix M pertaining to the matrix B, in accordance with embodiments of the invention;

FIG. 7 shows an equation relating transmission data, channel information, channel noise, and received data, in accordance with embodiments of the invention;

FIG. 8 shows a matrix comprising noise estimates for the channel, in accordance with embodiments of the invention; and

FIG. 9 shows a block diagram of an intercarrier interference cancellation logic, in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

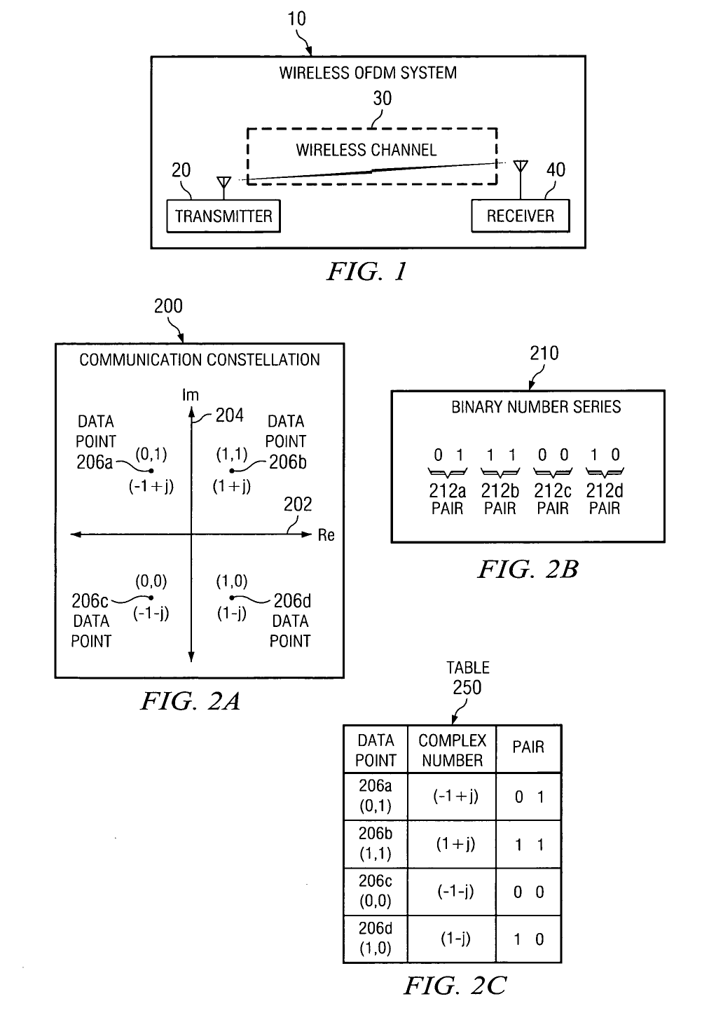

Described herein is an algorithm for reducing or eliminating the effects of intercarrier interference (ICI) on signals transmitted in an OFDM system. As shown in FIG. 1, the algorithm is presented in context of a wireless OFDM system 10 comprising a transmitter 20, a receiver 40, and a wireless channel 30 situated therebetween. To facilitate ease of understanding, OFDM modulation is first explained in context of the transmitter 20, followed by a description of ICI in context of the wireless channel 30. Finally, the ICI cancellation algorithm is described in context of the receiver 40.

As previously mentioned, OFDM involves dividing a data signal into multiple sub-signals and transmitting these sub-signals in parallel, each sub-signal carried on a different frequency. Prior to transmission, the transmitter 20 converts digital data (e.g., a series of binary numbers, such as from a video stream) into a series of complex numbers by mapping the binary numbers to a communication constellation (e.g., quadrature phaseshift key (QPSK), quadrature amplitude modulation (16-QAM)), described in further detail below. After the series of binary numbers is converted into a series of complex numbers using the communication constellation, the complex numbers are grouped into a parallel configuration (i.e., vectors) and are subsequently converted into voltage signals, as described below. The signals then are transmitted in parallel by transmitting the signals in vector format, one vector after another. A cyclic prefix may be prepended to at least some of the vector transmissions to separate the vectors from each other.

As mentioned above, binary numbers are mapped into complex numbers using communication constellations. FIG. 2a shows one such communication constellation 200. The communication constellation 200 comprises a real number axis 202, an imaginary number axis 204, and four data points 206a-d. The data points 206a-d may be assigned any suitable coordinate position values that may be determined at any time and by any entity, such as during manufacture. In the constellation 200, which is known as a QPSK constellation, data point 206a is assigned a coordinate position (0, 1), data point 206b is assigned a coordinate position (1, 1), data point 206c is assigned a coordinate position (0, 0), and data point 206d is assigned a coordinate position (1, 0). Each of the data points 206a-d may correspond to a pair of binary numbers in a series of binary numbers (i.e., data) to be transmitted. FIG. 2b shows one such series of binary numbers 210. Although FIG. 2b only shows the series 210 as comprising 8 bits, any number of bits may be used. As shown, the binary numbers in series 210 may be partitioned into pairs 212a-d. Specifically, pair 212a may comprise bits 0 and 1, pair 212b may comprise bits 1 and 1, pair 212c may comprise bits 0 and 0, and pair 212d may comprise bits 1 and 0.

The binary numbers in each of the pairs 212a-d corresponds to a coordinate associated with one of the four data points 206a-d. In particular, because data point 206a and pair 212a are both associated with binary numbers 0 and 1, data point 206a and pair 212a are associated with each other. The same concept applies for data point 206b and pair 212b, data point 206c and pair 212c, and data point 206d and pair 212d. As shown in FIG. 2a, besides being associated with a pair of binary coordinate numbers, each of the data points 206a-d also is associated with a complex number that is indicative of the data point's position relative to the real and imaginary axes 202, 204. Thus, data point 206a is associated with the complex number (−1+j), data point 206b is associated with the complex number (1+j), data point 206c is associated with the complex number (−1−j), and data point 206d is associated with the complex number (1−j). Accordingly, as shown in table 250 of FIG. 2c, because each of the pairs 212a-d of FIG. 2b is associated with one of the data points 206a-d of FIG. 2a, and because each of the data points 206a-d is associated with a complex number, each of the pairs 212a-d is also associated with a complex number. Thus, each pair of binary numbers in the series 210 is analyzed to determine with which data point 206a-d that pair is most closely associated, and each pair of binary numbers is converted into a complex number accordingly.

As previously mentioned, after the binary numbers are mapped into complex numbers using any suitable communication constellation, the complex numbers are converted into time-domain voltage signals by the transmitter. Specifically, the complex numbers are converted into voltage signals by first performing an inverse discrete Fourier transform (IDFT) operation as follows:
z=F^{H}Z (1)
where Z is the vector containing complex numbers to be transmitted, F^{H} denotes a known IDFT matrix generally used for determining inverse discrete Fourier transforms, and z is the resulting vector of such an operation on vector Z. By performing an IDFT operation on vector Z using the IDFT matrix F^{H}, the vector Z is converted from a time-domain sequence into a frequency-domain sequence. Each of the values of vector Z is mapped to a particular frequency in the time-domain sequence that is to be transmitted. The vector z is then processed by a pulse-shaping filter (e.g., a digital-to-analog converter), which converts the elements of z to voltage signals.

The transmitter 20 transmits the voltage signals serially (i.e., the data are grouped into a sequence of vectors, and each vector of the sequence is consecutively transmitted). As previously mentioned, each vector z is prepended with a cyclic prefix that separates that vector from a previous vector. Thus, for a vector z such as:
z=[z₁, . . . Zₙ₋ₖ₊₁, . . . Zₙ] (2)
the last k values are replicated and prepended to the vector z as a cyclic prefix:
z=[zₙ₋ₖ₊₁, zₙ₋ₖ₊₂, . . . zₙ, z₁, z₂, . . . Zₙ] (3)
and then the vector z is transmitted to the receiver 40 over wireless channel 30 using multiple frequencies. In at least some embodiments, each value of the vector Z is assigned a frequency different from those of the other values of vector Z.

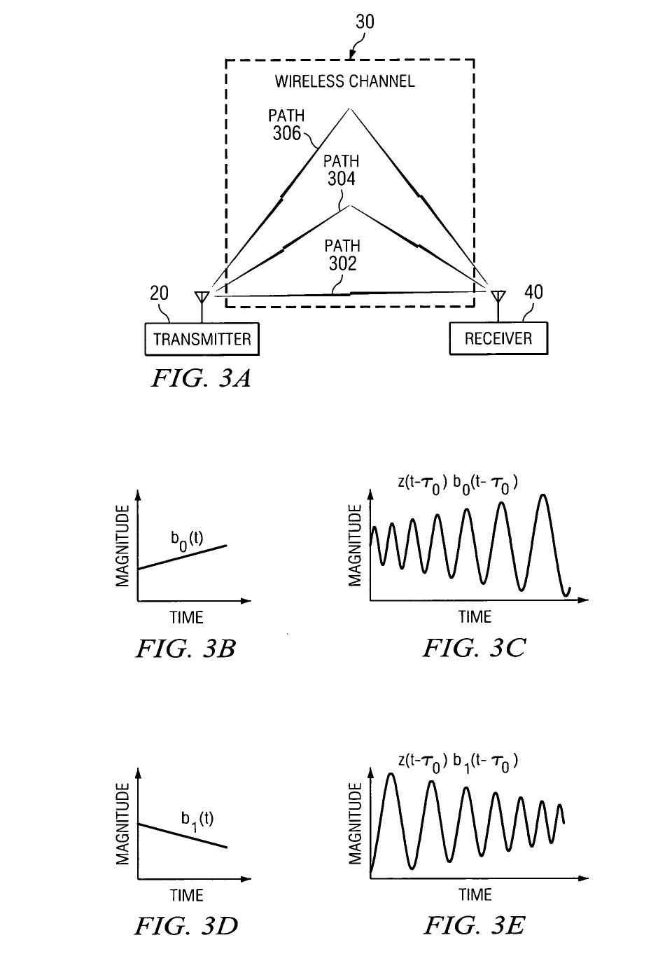

Once signal z(t) is transmitted (i.e., data of vector z is transmitted in time domain), the signal may follow any number of paths before reaching the receiver 40. For example, as shown in FIG. 3a, a signal z(t) that is broadcast from the transmitter 20 may follow multiple paths to the receiver 40. As mentioned before, although only three paths are shown, the signal z(t) may follow any number of paths. The signal z(t), once broadcast, may follow path 302 to the receiver 40. As shown, path 302 is the most direct path to the receiver 40. The signal z(t) also may follow path 304 to the receiver 40, where path 304 is the second most direct path to the receiver 40. Other paths also may be present, such as path 306, the third most direct path to the receiver 40. The path 302 may be such that the strength of the signal following path 302 increases with time. Conversely, the path 304 may be such that the strength of the signal following path 304 decreases with time. Such effects of the wireless channel 30 on the signals following paths 302, 304 are denoted by the function b(t).

Specifically, for path 302, the effect b₀(t) of the channel 30 on the signal z(t) may be written as:
z(t−′I₀)b₀(t−′I₀) (4)
where ′I₀ represents time delay in a time-variant channel. Similarly, for path 304, the effect b₁(t) of the channel 30 on the signal z(t) may be written as:
z(t−′I₀)b₀(t−′I₀) (5)

As shown in the example of FIG. 3b, b₀(t) may increase with time, so the strength (i.e., magnitude) of the signal following path 302 also increases with time, since the two are multiplied together as in (4). This increase in magnitude of b₀(t) affects the signal of (4) as shown in FIG. 3c. Similarly, as shown in FIG. 3d, b₁(t) may decrease with time, so the strength/magnitude of the signal following path 304 also decreases with time, since the two are multiplied together as in (5). This decrease in the magnitude of b₁(t) affects the signal of (5) as shown in FIG. 3e.

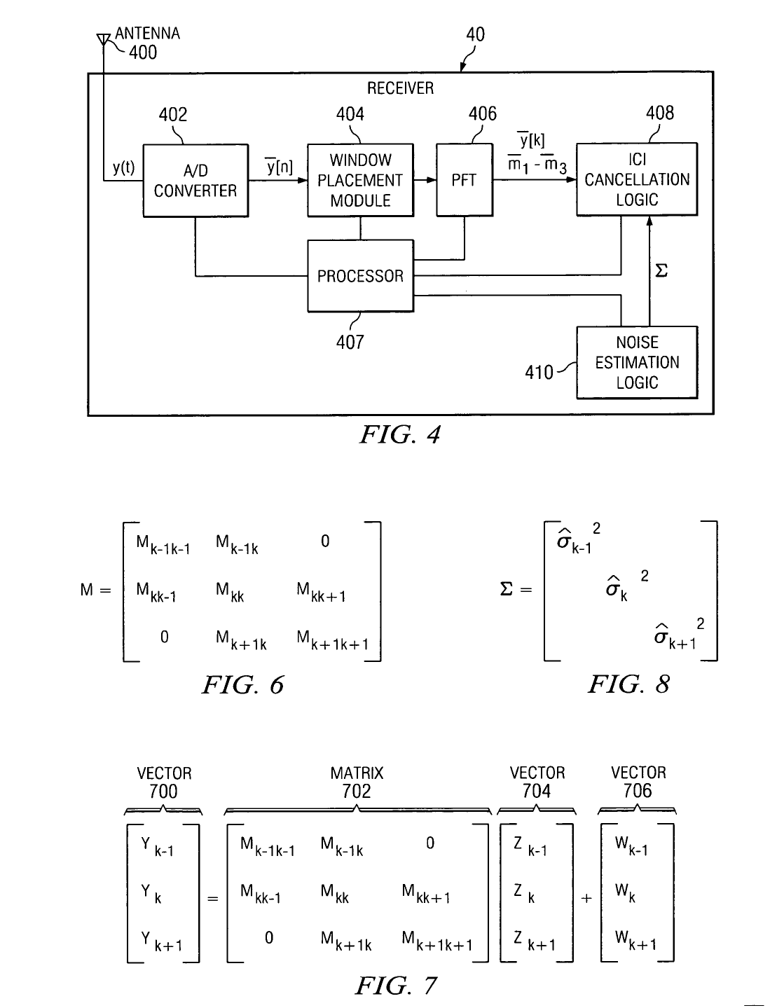

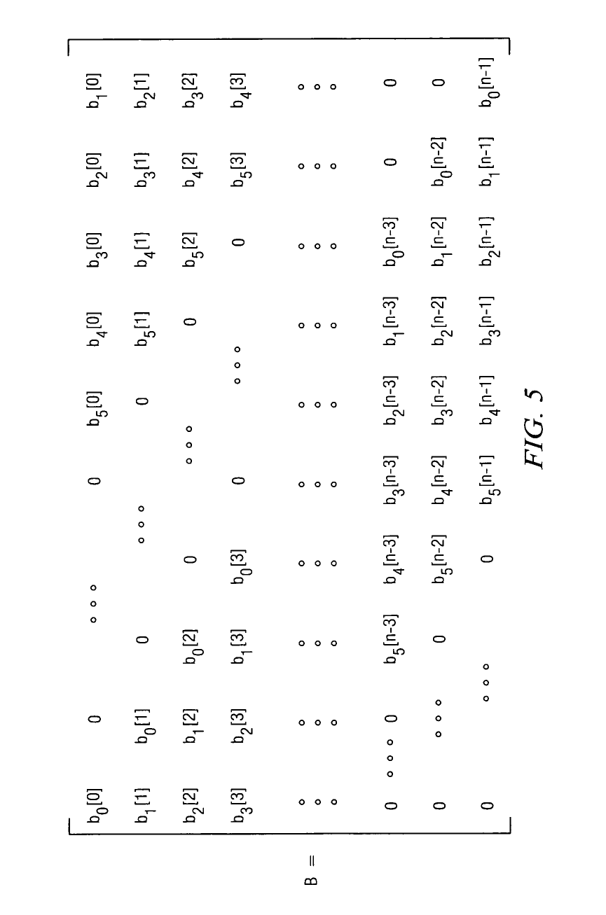

The receiver 40 receives and combines (4) and (5) (i.e., combines signals passing through some or all transmission paths) to produce a signal y(t). The receiver 40, shown in FIG. 4, comprises an antenna 400, an analog-to-digital (A/D) converter 402, a window placement module 404, a discrete Fourier transform module (DFT) 406, an ICI cancellation logic 408, a noise estimation logic 410 and a processor 407. The antenna 400 receives the signal y(t) and transfers the signal y(t) to the A/D converter 402. The AND converter 402 converts the analog y(t) signal into a vector y[n]. In turn, the window placement module 404 removes the cyclic prefix that was prepended to the signal in the transmitter 20 and passes the remaining portions of y[n] to the DFT 406. The DFT 406 converts the time-domain signal to a frequency-domain signal by performing a discrete Fourier transform on y[n] and outputs a vector y[k], which subsequently is transferred to the processor 407, whereupon relevant, desirable data is extracted from the vector y[k]. Entries in the vector y[k] may have the form:
MZ+w (6)
where w is noise from the channel 30, Z is the data, and M is a matrix that represents the channel conditions and is described in further detail below. The matrix M may be represented as:
M=FBF^{H} (7)
where F is any suitable, predetermined, discrete Fourier transform (DFT) matrix, F^{H} is any suitable, predetermined, inverse DFT (IDFT) matrix, and B is a matrix indicative of the channel conditions of the various paths that signals may travel along in the wireless channel 30. Vector y[k] then may be transferred to the ICI cancellation logic 408 whereby the effect of ICI is substantially reduced, as described further below. FIG. 5 shows an illustrative matrix B in greater detail.

The matrix B, as shown in FIG. 5, comprises data pertaining to channel conditions along various transmission paths. The values b₀[1] . . . b₀[N] are representative of the channel conditions along the most direct transmission path between the transmitter 20 and the receiver 40. In some embodiments, the most direct transmission path may, for example, be devoid of any obstacles (e.g., buildings). All other values in the matrix B, such as those denoted b₁[1] . . . b₁[N], b₂[1] . . . b₂[N], and so forth, are representative of the channel conditions along other transmission paths between the transmitter 20 and the receiver 40. In some embodiments, b₀ may be the most direct path between the transmitter 20 and the receiver 40, b, may be the second most direct path, b₂ may be the third most direct path, and so forth. The matrix B generally is a circularly wrapped matrix. Specifically, as shown in the figure, most or all values of {b₁, b₂ . . . b₅} are shifted circularly to the right by one column between each row. Accordingly, based on both this definition of matrix B and (7), matrix M may be written as shown in FIG. 6. In this example, the matrix M comprises 3 rows and 3 columns, although the matrix M may be of any suitable size. Similar to matrix B, the “diagonal” values Mₖ₋₁ₖ₋₁, Mₖₖ, and Mₖ₊₁ₖ₊₁ are associated with the most direct transmission path between transmitter 20 and receiver 40. All other values of the matrix M represent other transmission paths in the communication channel 30.

Each value (i.e., entry) k of the vector y of (6) is computed as follows:

$${Y}_{k} = {\sum }_{a} {M}_{ka} {Z}_{a} + {W}_{k} \qquad ( 8 )$$

As shown in (8), each value of the vector y is computed using multiple values of the matrix M and multiple values of the vector Z. Thus, each value of the vector y contains information pertaining not only to the relevant subcarrier frequency upon which the data traveled, but information pertaining to neighboring frequencies as well. Such an incorporation of data path information from neighboring sub-carrier frequencies introduces intercarrier interference (ICI) into calculations of each value of the vector y, and as previously explained, ICI is undesirable because it distorts the quality of received data. A model for ICI is shown in FIG. 7.

More specifically, FIG. 7 shows an expanded version of (8) in vector form. Vector 700 may be the y vector, matrix 702 may be the matrix M shown in FIG. 6, vector 704 may be the Z vector, and vector 706 may be a W (i.e., noise) vector. As in (8), the multiplication of matrix M with vector Z for each value in the vector y includes not only the multiplication of relevant values of M and Z, but those of neighboring frequencies, as well. For example, yₖ may be calculated as:
yₖ=(Mₖₖ₋₁)Zₖ₋₁+(Mₖₖ)Zₖ+(Mₖₖ+1)Zₖ₊₁+Wₖ (9)

In (9), the terms yₖ and (Mₖₖ)Zₖ are relevant to determining the value of Zₖ. The remaining terms may be undesirable because they are either ICI from neighboring frequencies (i.e., (Mₖₖ−1)Zₖ−1, (Mₖₖ+1)Zₖ+1) or noise (i.e., Wₖ). Eliminating the presence of these undesirable terms may substantially improve the accuracy of transmission data estimations.

The effects of ICI may be reduced or even eliminated by determining an unbiased, linear, minimum mean-squared error estimate of the transmitted data zₖ. In this way, the signal corruption introduced by neighboring data carriers zₖ₋₁ and zₖ₊₁ while calculating yₖ in (8) and (9), and the corruption introduced by the additive noise Wₖ, may be reduced or even eliminated. Although the scope of disclosure encompasses any technique that may be used to eliminate ICI, the ICI preferably is reduced or even eliminated by the ICI cancellation logic 408 which calculates the equalization equation:

$${\hat{z}}_{k} = \frac{{{( {m}_{2}^{*} )}^{T} [ {{m}_{1} ( {m}_{1}^{*} )}^{T} + {{m}_{3} ( {m}_{3}^{*} )}^{T} + \sum ]}^{- 1} ( {y}_{3} )}{{( {m}_{2}^{*} )}^{T} {( {{m}_{1} ( {m}_{1}^{*} )}^{T} + {{m}_{3} ( {m}_{3}^{*} )}^{T} + \sum )}^{- 1} ( {m}_{2} )} \qquad ( 10 )$$

where, in at least some embodiments, m₁, m₂, and m₃ denote the first, second and third A columns of matrix M, respectively, \hat{z}ₖ is an estimate of the k^{th} term of the vector z (i.e., the data prior to ICI corruption), and y₃ is given by:

$${y}_{3} = [ \begin{matrix}{y}_{k - 1} \\ {y}_{k} \\ {y}_{k + 1}\end{matrix} ] \qquad ( 11 )$$

The expression “τ” in (10) is given by the matrix Σ shown in FIG. 8, where the entries of Σ are estimates of noise variance for Wₖ₋₁, Wₖ, and Wₖ₊₁. The remaining portions of the matrix Σ preferably are vacant. Performing the algorithm above (i.e., in (10)) effectively removes the presence of neighboring terms from calculations used to obtain desired data from received signals (e.g., for (9), (Mₖₖ₋₁)Zₖ₋₁ and (Mₖₖ₊₁)Zₖ₊₁), thus substantially reducing the effects of ICI and enabling the receiver 40 to extract desirable data (e.g., Zₖ) from the received data (i.e., y[k]) with considerable accuracy. However, Σ is incorporated into (10) because, in some cases, eliminating or reducing the effect of ICI as described above may boost the effect of the additive noise Wₖ. The matrix Σ reduces this effect. More specifically, the entries of matrix Σ are real numbers generated by the noise estimation logic 410 in the receiver 40. In particular, the estimation logic 410 measures the error between at least some values of Yₖ and corresponding estimates of the received data Rₖ prior to the addition of noise Wₖ:
Eₖ=Yₖ−Rₖ (12)
and thus the squared error is:
E²ₖ=(Yₖ−Rₖ)² (13)
which is averaged to generate the entries for the matrix Σ. The value of Rₖ is an estimate of data received from the channel absent the effect of noise Wₖ. Rₖ is the product of an estimate of Zₖ and the channel estimate Mₖₖ. The receiver estimates Zₖ using hard slicer division. The channel estimate Mₖₖ may be produced by the same algorithm that is used to calculate the M matrix (e.g., (7)). The receiver multiplies these two estimates to determine Rₖ.

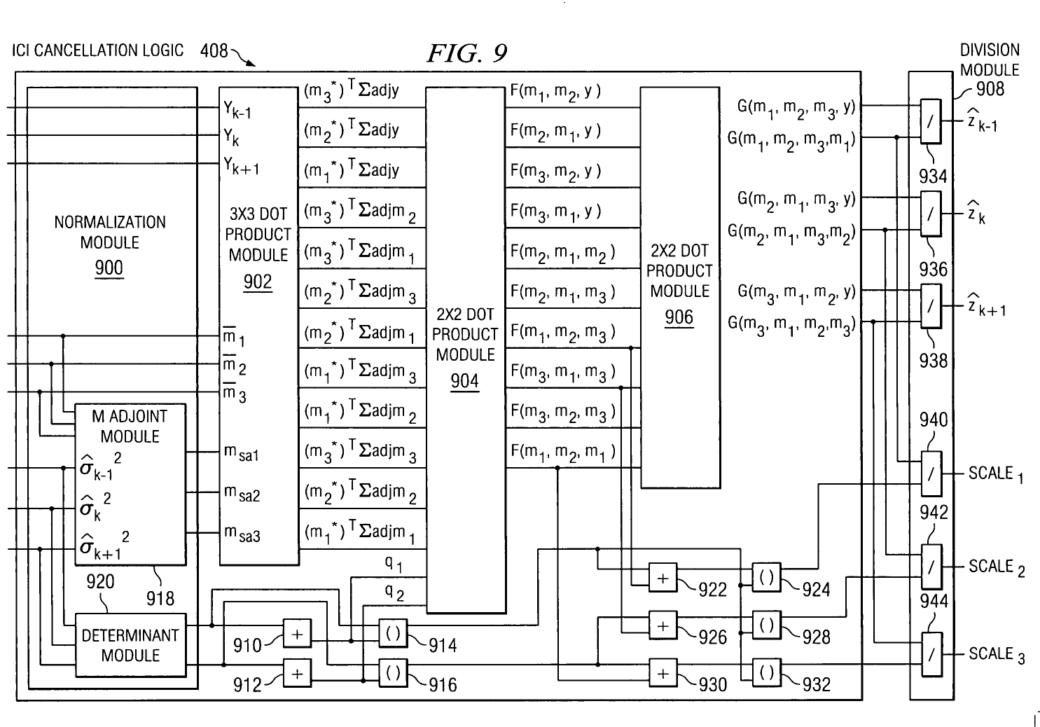

A receiver 40 may use any suitable circuit logic, executable code, or combination thereof to implement (10). In at least some embodiments, the receiver 40 may implement (10) using the ICI cancellation logic 408 such as that shown in FIG. 9. Specifically, the logic 408 of FIG. 9 comprises, among other things, a normalization module 900 comprising an adjoint module 918 and a determinant module 920. The logic 408 may further comprise a 3×3 dot product module 902, a 2×2 dot product module 904, a 2×2 dot product module 906, a division module 908, addition modules 910, 912, 922, 926, and 930, and multiplication modules 914, 916, 924, 928 and 932. The normalization module 900 has as inputs the values of the y₃ vector in (11), as well as vectors m₁, m₂ and M₃, all of which preferably are received from the DFT 406. The normalization module 900 also receives diagonal values of the noise variance matrix Σ in FIG. 8. These input values A are processed by the dot product modules 902, 904 and 906 to produce \hat{z}ₖ and other associated terms at the division module 908.

More specifically, the adjoint module 918 receives as input vectors m₁, m₂ and m₃ as well as the diagonal values of the noise variance matrix Σ and outputs adjoint matrices msa1, msa2 and msa3 to the dot product module 902. The determinant module 920 receives as inputs the three values of the noise variance matrix and outputs two determinant signals to the addition modules 910, 912 and the multiplication modules 914, 916 as described further below.

The terms zₖ₋₁, zₖ and zₖ₊₁ that are output from the division module 908 are all calculated in a similar manner. For example, the value zₖ₋₁ may be defined as:

$$\begin{matrix}{\hat{z}}_{k - 1} = \frac{{( {m}_{1}^{*} )}^{T} {( {{m}_{2} ( {m}_{2}^{*} )}^{T} + {{m}_{3} ( {m}_{3}^{*} )}^{T} + Σ )}^{- 1} y}{{( {m}_{1}^{*} )}^{T} {( {{m}_{2} ( {m}_{2}^{*} )}^{T} + {{m}_{3} ( {m}_{3}^{*} )}^{T} + Σ )}^{- 1} {m}_{1}} \\ = \frac{G ( {m}_{1} , {m}_{2} , {m}_{3} , y )}{G ( {m}_{1} , {m}_{2} , {m}_{3} , {m}_{1} )}\end{matrix} \qquad ( 14 )$$

The term (m₂(m₂*)^{T}+m₃(m₃*)^{T}+Σ)⁻¹ may be rewritten using the Matrix Inversion Lemma as:

$${( {{m}_{2} ( {m}_{2}^{*} )}^{T} + {{m}_{3} ( {m}_{3}^{*} )}^{T} + Σ )}^{- 1} = {( {{m}_{3} ( {m}_{3}^{*} )}^{T} + Σ )}^{- 1} - \frac{{( {{m}_{3} ( {m}_{3}^{*} )}^{T} + Σ )}^{- 1} {{m}_{2} ( {m}_{2}^{*} )}^{T} {( {{m}_{3} ( {m}_{3}^{*} )}^{T} + Σ )}^{- 1}}{1 + {( {m}_{2}^{*} )}^{T} {( {{m}_{3} ( {m}_{3}^{*} )}^{T} + Σ )}^{- 1} {m}_{2}} \qquad ( 15 )$$

The entire numerator of (14) can then be rewritten using (15) as:

$$G ( {m}_{1} , {m}_{2} , {m}_{3} , y ) = \{ {( {m}_{1}^{*} )}^{T} {( {{m}_{3} ( {m}_{3}^{*} )}^{T} + Σ )}^{- 1} y \} - \frac{\{ {( {m}_{1}^{*} )}^{T} {( {{m}_{3} ( {m}_{3}^{*} )}^{T} + Σ )}^{- 1} {m}_{2} \} \{ {( {m}_{2}^{*} )}^{T} {( {{m}_{3} ( {m}_{3}^{*} )}^{T} + Σ )}^{- 1} y \}}{1 + \{ {( {m}_{2}^{*} )}^{T} {( {{m}_{3} ( {m}_{3}^{*} )}^{T} + Σ )}^{- 1} {m}_{2} \}} \qquad ( 16 )$$

Simplifying the first term (m₁*)^{T}(m₃(m₃*)^{T}+Σ)⁻¹y, the Matrix Inversion Lemma may be used to write equation (16) as:

$${( {m}_{1}^{*} )}^{T} {( {{m}_{3} ( {m}_{3}^{*} )}^{T} + Σ )}^{- 1} y = {( {m}_{1}^{*} )}^{T} [ {\sum }^{- 1} - \frac{{\sum }^{- 1} {{m}_{3} ( {m}_{3}^{*} )}^{T} {\sum }^{- 1}}{1 + {( {m}_{3}^{*} )}^{T} {\sum }^{- 1} {m}_{3}} ] y \qquad ( 17 )$$

Because

$${\sum }^{- 1} = \frac{{\sum }_{adj}}{{σ}_{1}^{2} {σ}_{2}^{2} {σ}_{3}^{2}} = \frac{{\sum }_{adj}}{det ( Σ )}$$

the denominator of (17) may be written as det(Σ)+m₃^{H}Σ_{adj}m₃ after multiplying through by det(Σ). Thus, (17) may be written as:

$${( {m}_{1}^{*} )}^{T} {( {{m}_{3} ( {m}_{3}^{*} )}^{T} + Σ )}^{- 1} y = \frac{( det ( Σ ) + {( {m}_{3}^{*} )}^{T} {\sum }_{adj} {m}_{3} ) {( {m}_{1}^{*} )}^{T} {\sum }_{adj} y - ( {( {m}_{1}^{*} )}^{T} {\sum }_{adj} {m}_{3} ) {( {m}_{3}^{*} )}^{T} {\sum }_{adj} y}{( det ( Σ ) + {( {m}_{3}^{*} )}^{T} {\sum }_{adj} {m}_{3} ) det ( Σ )} \qquad ( 18 )$$

Without division, (18) becomes:
(m₁*)^{T}(m₃m₃*)^{T}+Σ)⁻¹y(det(Σ)(m₃*)^{T}Σ_{adj}m₃)det(Σ)=(det(Σ)+m₃^{H}Σ_{adj}m₃)m₁^{H}Σ_{adj}y−(m₁^{H}Σ_{adj}m₃)m₃^{H}Σ_{adj}y (19)

Defining the term Q1(m₃) as the term and further defining the term R1(m₃) as the term, the function Q employs Q1(m3)det(Σ) (det(Σ)+m₃^{H}Σ_{adj}m₃) only addition and the function R employs only multiplication. Accordingly, (19) may be rewritten as:

$$\begin{matrix}{( {m}_{1}^{*} )}^{T} {( {{m}_{3} ( {m}_{3}^{*} )}^{T} + \sum )}^{- 1} y = \frac{Q 1 ( {m}_{3} ) {( {m}_{1}^{*} )}^{T} {\sum }_{adj} y - ( {( {m}_{1}^{*} )}^{T} {\sum }_{adj} {m}_{3} ) {( {m}_{3}^{*} )}^{T} {\sum }_{adj} y}{R 1 ( {m}_{3} )} \\ = \frac{F ( {m}_{1} , {m}_{3} , y )}{R 1 ( {m}_{3} )}\end{matrix} \qquad ( 20 )$$

Other F functions used to compute G(m₁,m₂,m₃,y) may be defined as follows:
F(m₁,m₃,m₂)=Q1(m₃)(m₁*)^{T}Σ_{adj}m₂−((m₁*)^{T}Σ_{adj}m₃)((m₃*)^{T}Σ_{adj}m₂) (21)
F(m₂,m₃,y)=Q1(m₃)(m₂*)^{T}Σ_{adj}y−((m₂*)^{T}Σ_{adj}m₃)((m₃*)^{T}Σ_{adj}y) (22)
F(m₂,m₃,m₂)=Q1(m₃)(m₂*)^{T}Σ_{adj}m₂−((m₂*)^{T}Σ_{adj}m₃)((m₃*)^{T}Σ_{adj}m₂) (23)

The F functions (21)-(23) are 2×2 dot products determined by dot product module 904 whose input terms are the results of 3×3 dot products determined by dot product module 902. (21)-(23) may be used to determine outputs of the dot product module 906 (called “G functions”), as shown at the outputs of dot product module 906 in FIG. 9.

The G function in (16) may now be written as:

$$G ( {m}_{1} , {m}_{2} , {m}_{3} , y ) = \frac{F ( {m}_{1} , {m}_{3} , y )}{R1 ( {m}_{3} )} - \frac{F ( {m}_{1} , {m}_{3} , {m}_{2} ) F ( {m}_{2} , {m}_{3} , y )}{( 1 + \frac{F ( {m}_{2} , {m}_{3} , {m}_{2} )}{R1 ( {m}_{3} )} ) {R1 ( {m}_{3} )}^{2}} \qquad ( 24 )$$

which may be rewritten as:
G(m₁,m₂,m₃,y)R2(m₁)=F(m₁,m₃,y)[R₁(m₃)+F(m₂,m₃,m₂)]−F(m₁,m₂,m₂)F(m₂,m₃,y) (25)
where the scale factor R2(m₁) may be defined as:
R2(m₁)=Q2(m₁)R₁(m₃)=Q2(m₁)[Q1(m₃) det(Σ)] (26)

By ignoring the scale factor for G, (25) may be rewritten as:
G(m₁,m₂,m₃,y)=F(m₁,m₃,y)Q2(m₁)−F(m₁,m₃,m₂)F(m₂,m₃,y) (27)
where Q2(m₁)=[R1(m₃)+F(m₂,m₃,m₂)]. The G function represents the outputs of dot product module 906, which are 2×2 dot products of the F functions output by the dot product module 904.

To determine the outputs of the division module 908, pairs of the G functions output by the dot product module 906 are divided using dividers 934-938. Scale factors may be determined using at least some of the G function outputs of the dot product module 906 as well as outputs of the determinant module 920 that have been mathematically manipulated by addition blocks 910, 912, 922, 926, 930 and multiplication blocks 914, 916, 924, 928, 932. These G function outputs and determinant module 920 outputs are divided using dividers 940, 942, 944 to determine the scale factors, as described below. Accordingly, the output of divider block 934 may be determined as:

$${\hat{z}}_{k - 1} = \frac{G ( {m}_{1} , {m}_{2} , {m}_{3} , y )}{G ( {m}_{1} , {m}_{2} , {m}_{3} , {m}_{1} )} \qquad ( 28 )$$

Similarly, the outputs of divider blocks 936, 938 may be determined as:

$$\begin{matrix}{\hat{z}}_{k} = \frac{G ( {m}_{2} , {m}_{1} , {m}_{3} , y )}{G ( {m}_{2} , {m}_{1} , {m}_{3} , {m}_{2} )} & ( 29 ) \\ {\hat{z}}_{k + 1} = \frac{G ( {m}_{3} , {m}_{1} , {m}_{2} , y )}{G ( {m}_{3} , {m}_{1} , {m}_{2} , {m}_{3} )} & ( 30 )\end{matrix}$$

and the scale factors output by the divider modules 940, 942, 944 may be determined as:

$$\begin{matrix}{scale}_{1} = \frac{G ( {m}_{1} , {m}_{2} , {m}_{3} , {m}_{1} )}{R2 ( {m}_{1} )} & ( 31 ) \\ {scale}_{2} = \frac{G ( {m}_{2} , {m}_{1} , {m}_{3} , {m}_{2} )}{R2 ( {m}_{2} )} & ( 32 ) \\ {scale}_{3} = \frac{G ( {m}_{3} , {m}_{1} , {m}_{2} , {m}_{3} )}{R2 ( {m}_{3} )} & ( 33 )\end{matrix}$$

The above derivations are illustrative of some of the functions produced by the dot product modules 902, 904, 906 and the division module 908. In at least some embodiments, there may be twelve 3×3 dot products that are produced by the dot product module 902:
m₁^{H}Σ_{adj}m₁ (34a)
m₁^{H}Σ_{adj}m₂ (34b)
m₁^{H}Σ_{adj}m₃ (34c)
m₂^{H}Σ_{adj}m₁ (34d)
m₂^{H}Σ_{adj}m₂ (34e)
m₂^{H}Σ_{adj}m₃ (34f)
m₃^{H}Σ_{adj}m₁ (34g)
m₃^{H}Σ_{adj}m₂ (34h)
m₃^{H}Σ_{adj}m₃ (34i)
m₁^{H}Σ_{adj}y (34j)
m₂^{H}Σ_{adj}y (34k)
m₃^{H}Σ_{adj}y (34l)

The dot product module 904 receives (34a)-(34l) as inputs and performs 2×2 dot product operations on (34a)-(34l) to output the ten 2×2 dot product F functions below:
F(m₁,m₂,y)=q2*m₁^{H}Σ_{adj}y−m₁^{H}Σadjm₂*m₂^{H}Σ_{adj}y (35a)
F(m₁,m₂,m₁)=q2*m₁^{H}Σ_{adj}m₁−m₁^{H}Σadjm₂*m₂^{H}Σ_{adj}m₁ (35b)
F(m₂,m₁,y)=q1*m₂^{H}Σ_{adj}y−m₂^{H}Σadjm₁*m₁^{H}Σ_{adj}y (35c)
F(m₂,m₁,m₂)=q1*m₂^{H}Σ_{adj}m₂−m₂^{H}Σadjm₁*m₁^{H}Σ_{adj}m₂ (35d)
F(m₃,m₁,m₃)=q2*m₃^{H}Σ_{adj}m₃−m₃^{H}Σadjm₂*m₂^{H}Σ_{adj}m₃ (35e)
F(m₁,m₂,m₃)=q2*m₁^{H}Σ_{adj}m₃−m₁^{H}Σadjm₂*m₂^{H}Σ_{adj}m₃ (35f)
F(m₃,m₂,y)=q2*m₃^{H}Σ_{adj}y−m₃^{H}Σadjm₂*m₂^{H}Σ_{adj}y (35g)
F(m₂,m₁,m₃)=q1*m₂^{H}Σ_{adj}m₃−m₂^{H}Σadjm₁*m₁^{H}Σ_{adj}m₃ (35h)
F(m₂,m₁,y)=q1*m₃^{H}Σ_{adj}y−m₃^{H}Σadjm₁*m₁^{H}Σ_{adj}y (35i)
F(m₃,m₁,m₃)=q1*m₃^{H}Σ_{adj}m₃−m₃^{H}Σadjm₁*m₁^{H}Σ_{adj}m₃ (35j)

Using the F functions (35a)-(35j) above, the dot product module 906 may produce six G functions as shown below:
G(m1,m2,m3,m1)=F(m1,m2,m1)[r2+F(m3,m2,m3)]−F(m1,m2,m3)*F(m3,m2,m1) (36a)
G(m2,m1,m2,y)=F(m2,m1,y)[r1+F(m3,m1,m3)]−F(m2,m1,m3)*F(m3,m1,y) (36b)
G(m2,m1,m3,m2)=F(m2,m1,m2)[r1+F(m3,m1,m3)]−F(m2,m1,m3)*F(m3,m1,m2) (36c)
G(m1,m2,m3,y)=F(m1,m3,y)[r2+F(m3,m2,m3)]−F(m1,m2,y)*F(m3,m2,y) (36d)
G(m3,m1,m2,y)=F(m3,m2,m3)[r2+F(m1,m2,m1)]−F(m3,m2,m1)*F(m1,m1,y) (36e)
G(m3,m1,m2,m3)=F(m3,m2,m3)[r2+F(m1,m2,m1)]−F(m3,m2,m1)*F(m1,m3,m3) (36j)

The division module 934 may determine an output \hat{z}ₖ₋₁ by dividing (36a) by (36b). Similarly, the division module 936 may determine an output \hat{z}ₖ by dividing (36c) by (36d), and the division module 938 may determine an output \hat{z}ₖ₊₁ by dividing (34e) by (36f). The output \hat{z}ₖ is the desired output as calculated in (10). Thus, the ICI cancellation logic 408 has at least partially cancelled ICI by determining an unbiased, linear, minimum-squared error estimate of the received data signal.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method, comprising:
wirelessly transmitting and receiving a data signal in an orthogonal frequency division multiplexing (OFDM) system; and
in the frequency domain, at least partially removing overlap between a first received subcarrier frequency data and a second received subcarrier frequency data.

2. The method of claim 1, wherein at least partially removing the overlap comprises determining an unbiased, linear, minimum-squared error estimate of the transmitted data signal.

3. The method of claim 1, wherein at least partially removing the overlap comprises removing intercarrier interference (ICI).

4. The method of claim 1 further comprising at least partially removing additive noise.

5. The method of claim 4, wherein at least partially removing additive noise comprises determining the difference between an estimate of the received data signal prior to the addition of noise and a form of the data signal actually received.

6. The method of claim 1, wherein no data is transmitted on a subcarrier frequency between the subcarrier frequencies associated with the first and second subcarrier frequency.

7. An orthogonal frequency division multiplexing (OFDM) communication system comprising a receiver adapted to, in the frequency domain, determine an unbiased, linear, minimum-squared error estimate of a transmitted data signal.

8. The system of claim 7, wherein the receiver is contained in a battery-operated communication device.

9. The system of claim 7, wherein the receiver at least partially removes additive noise.

10. The system of claim 7, wherein substantially no data is present on a subcarrier frequency between the first and second subcarrier frequencies.

11. A receiver, comprising:
a first logic adapted to decode a received data signal; and
a second logic coupled to the first logic and adapted to at least partially remove the overlap between received data on neighboring subcarrier frequencies in the frequency domain;
wherein the receiver is in an orthogonal frequency division multiplexing (OFDM) system.

12. The receiver of claim 11, wherein the second logic at least partially removes the overlap by determining an unbiased, linear, minimum-squared error estimate of a transmitted data signal.

13. The receiver of claim 11, wherein the second logic at least partially removes additive noise in the received signal.

14. The receiver of claim 11, wherein data is not received on a subcarrier frequency that is between the first and second subcarrier frequencies.

15. A logic, comprising:
a plurality of dot product modules adapted to determine the dot product of a received data vector, a channel condition vector and a noise variance vector; and
a divider module adapted to use the dot product to determine, in the frequency domain, a minimum-squared error estimate of a transmitted data signal.

16. The logic of claim 15, wherein the logic is in an orthogonal frequency division multiplexing (OFDM) system.

17. The logic of claim 15, wherein the logic at least partially removes an overlap between received data on neighboring subcarrier frequencies.

18. The logic of claim 15, wherein the logic at least partially removes additive noise.
